(19) United States
(12) Patent Application Publication
(10) Pub. No.: US 2022/0073247 A1
(43) Pub. Date: Mar. 10, 2022

(54) ELEMENT FOR MOISTURE CONTROL IN A CONTAINER

(71) Applicant: TIPITALIA S.r.l., Piacenza (IT)

(72) Inventors: Andrea BERZOLLA, Piacenza (IT); Andrea BASSO, Breganzona (CH)

(21) Appl. No.: 17/423,128

(22) PCT Filed: Jan. 17, 2020
(86) PCT No.: PCT/IB2020/050364

§ 371 Date: Jul. 15, 2021

(30) Foreign Application Priority Data
Jan. 17, 2019 (IT) 102019000000757

(51) Int. Cl. B65D 75/32; B65D 81/20; B65D 81/26; B65D 81/28; A23L 3/3418

(52) U.S. Cl. CPC B65D 75/325; B65D 81/2076; A23L 3/3418; B65D 81/28; B65D 81/267

(57) ABSTRACT

The present invention refers to an element (E) for moisture control and to the use of said element for preserving substrates in controlled moisture conditions.

The present invention refers to an element (E) for moisture control and to the use of said element for preserving substrates in controlled moisture conditions.

In developed and developing countries, most food products are packaged in disposable containers or in reusable containers so as to be able to be put on sale and stored before consumption. However, food products, even if packaged, can undergo changes to the organoleptic and structural characteristics, which can make them unpleasant or, even, potentially dangerous for the consumer. For example, stored food products can lose moisture, and thus have an appearance of being too dry, or absorb moisture from the environment, with the development of degradation phenomena, also bacterial, which lead to unpleasant smells and flavours and to the potential formation of toxic substances.

U.S. Pat. No. 5,037,459 B1 describes an element for moisture control in a sealed container, specifically, a pack of cigarettes, comprising an aqueous solution of a salt and/or another buffer substance, contained in a casing that allows the exchange of moisture with the inside of the sealed container. The examples describe a rectangular or cigarette-shaped casing.

US 2003/0203081 relates to an element for maintaining a predetermined moisture level in a food package, which comprises a polymeric casing containing an aqueous solution saturated with a salt or a sugar, a gelling agent such as an alginate or xanthan gum and a substance capable of removing the oxygen present in the package. Said casing comprises at least one wall consisting of a polymeric material that is permeable to moisture. The only example present in US 2003/0203081 relates to a package for preserving cigars in controlled-moisture conditions and it is shown that the presence of an element as described above does not significantly delay the formation of moulds on the substrate. Indeed, it is described that moulds develop after 3 months in the control sample, after about 4 months in the sample containing the claimed element and that a significant amount of mould is present in both samples after 5 months.

The devices that are currently available do not ensure the preservation of food and food ingredients for a prolonged time and the improvement of the preservation of food for long periods, at controlled or room temperature, is still greatly needed.

The purpose of the present invention is to provide an element for preventing the degradation of food, food ingredients and similar substances and to preserve and/or season them in optimal conditions both in refrigerated and controlled environments and in atmospheric conditions, i.e. also outside of refrigerating apparatuses and rooms like seasoning rooms.

The object of the present invention is an element (E) for moisture control in a container, comprising at least:

a base (B) comprising one or more layers of polymeric film, optionally stretchable so that the element (E) may be adapted to said container, wherein:
when there are two or more layers of said base, they optionally define at least one internal cavity (C1);
said base has two or more raised portions (R) made of polymeric material, positioned on one or on both sides of the base, each of said raised portions (R) defining an internal cavity (C2) and being distanced from each other so as to allow the passage of a gaseous flux between the two or more raised portions (R),
one or more of said cavities (C1) and/or (C2) contain a gas, preferably air, or an aqueous solution or suspension (S) comprising at least one food-grade substance selected from an inorganic or organic salt, a sugar, a polyol or a polyprotic acid and/or mixtures thereof, with the condition that
at least one of the cavities (C1) and (C2) contains the solution or suspension (S) and that
the one or more cavity containing the solution or suspension (S) is enclosed, at least partially, by a film (PP) impervious to water and permeable to moisture.

The object of the present invention is an element (E) for moisture control in a container, comprising at least:
a base (B) having two sides and comprising one or more layers of polymeric film, optionally stretchable so that the element (E) may be adapted to fit said container,
layer comprising a plurality of microspheres or microcapsules (MSC), having maximum dimensions from 1 to 1000 micrometres, preferably from 200 to 600 micrometres, comprising an aqueous solution or suspension (S) comprising at least one food grade substance selected from an inorganic or organic salt, a sugar, a polyol, a polyprotic acid and/or mixtures thereof, positioned in contact with at least one side (F1) of the base (B);
a coating layer (CO) impervious to water and permeable to moisture positioned in contact with the layer of microspheres or microcapsules (MSC) on the outer side of the element (E).

A further object of the present invention is a container for storage in controlled moisture of a substrate, preferably for preserving and/or seasoning food and food ingredients, comprising the element (E) for moisture control as defined above, preferably in the shape of a sealable box or a single-use container, optionally comprising an atmosphere consisting substantially of one or more inert gases, preferably selected from nitrogen, carbon dioxide, a noble gas and mixtures thereof.

An object of the present invention is a method for producing the element (E) comprising a coating layer (CO) and microspheres or microcapsules (MSC) as described above, which comprises the following steps:
i. applying at least one layer of microspheres or microcapsules (MSC), optionally dispersed in a coating material or in an adhesive material), on at least one side (F1) of the base (B);
ii. applying the coating layer (CO) on the at least one layer of microspheres or microcapsules (MSC) obtained in step i.;
iii. laminating the coating layer (CO) so as to obtain the adhesion thereof to the layer applied in step i. on the outer side of the element (E).

A further object of the present invention is the use of the container as defined above for preserving and/or seasoning a food or a food ingredient, preferably in which said food is at least one from cold cuts (processed meat), a dairy product, fruit, a vegetable, a food preparation such as sauces and a pre-cooked food, ingredients for food preparations, a fish product and confectionery. In the present invention, the term “substrate” is meant to indicate a substance or an object that must be preserved in controlled moisture conditions. Non-limiting examples of substrates in the invention are artworks, electrical and electronic devices, musical instruments, prints and, in general, items containing or made from paper, furnishings and, in general, items containing or made from wood, food and food ingredients.

The term “food” (or «food product», or «foodstuffs»), according to the definition provided in Art.2 of Regulation CE 178 of Jan. 28, 2002, is meant to indicate any substance, or a mixture of substances, of natural origin that is partially processed, processed or unprocessed, raw, cooked or partially cooked, intended to be ingested, or which can reasonably be presumed will be ingested by humans, like, as non-limiting examples, meats, cold cuts, dairy products, fruit, vegetables, baked products, desserts, fish products and similar. This definition also includes animal feeds, food spices, tobacco and tobacco derivatives. This definition does not include live animals, with the exclusion of live animals prepared to be put on sale for the purposes of human consumption, vegetables before harvesting, medicines, cosmetics, controlled or psychotropic substances, residues and contaminants.

The term “ingredient for food use” is meant to indicate any substance, or mixture of substances, intended to form part of, if necessary after suitable processing like grinding or cooking, or to constitute a food or to be ingested together with a food according to the definition indicated above, like, as non-limiting examples, cereals, animal and vegetable flours, flavourings and spices, condiments, animal or vegetable extracts, salts, bases and acids for food use, pH and flavour regulators or food preservatives, preparations, like sauces, and similar.

The term “plurality” is meant to indicate a number equal to or greater than two.

The term “size” is meant to indicate the diameter for spherical particles or the length of the larger axis for particles of non-spherical shape, for example irregular or ellipsoidal, like capsules and microcapsules.

The term “base” of an element is meant to indicate a panel or sheet, rigid or flexible, having at least two sides having greater extension than the other walls of the base, which can comprise one or more layers of one or more materials. As a non-limiting example, the base of an element can be shaped like a rectangular or approximately rectangular sheet or other shapes suitable for the purposes of the invention. Unless otherwise indicated, in the present invention the percentages and the amounts of a component in a mixture are meant to refer to the weight of such a component with respect to the total weight of the mixture.

Unless otherwise indicated, in the present invention the indication that a composition “comprises” one or more components or substances means that other components or substances may be present in addition to the one, or those, specifically indicated.

Unless otherwise indicated, in the present invention a range of values indicated for a magnitude, for example the content by weight of a component, includes the lower limit and the upper limit of the range. For example, if the content by weight or by volume of a component A is indicated as “from X to Y”, where X and Y are numerical values, A can be X or Y or any of the intermediate values.

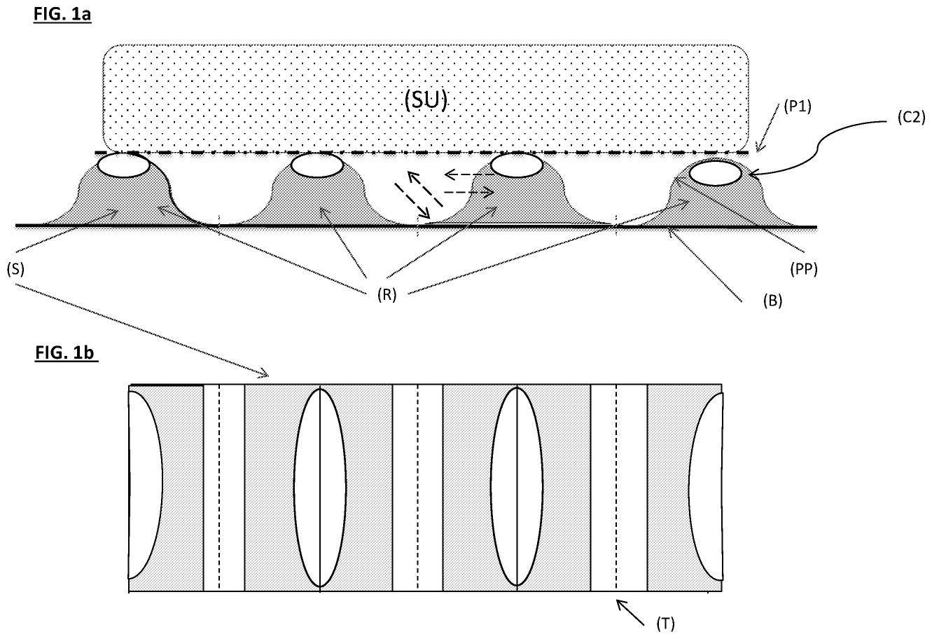

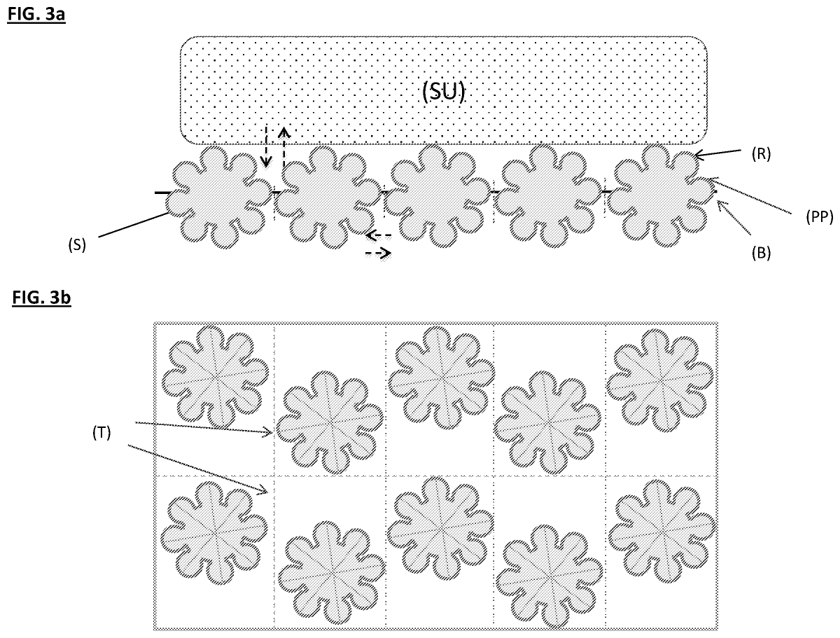

FIGS. 1-8 illustrate some embodiments of the invention, without limiting the scope thereof.

The substrate is indicated with (SU) and the solution or suspension (S) is shown in grey.

FIGS. 1-4 relate to devices in which the solution or suspension (S) is contained in the cavity (C2) inside the raised portions (R) and the base (B) does not have a cavity (C1), with section view (1a-4a) or plan view (1b-4b). (B) indicates the base with breathable or non-breathable wall. (P1) indicates the removable separation adhesive film (optional).

The caps containing air bubbles (optional) contained in the cavity (C2) are indicated in FIGS. 1, 2 and 4 (without colour).

The interchange of moisture is indicatively represented with two arrows with a broken line.

The weakened lines (T) or perforations to promote tearing (optional) are indicated with dashes.

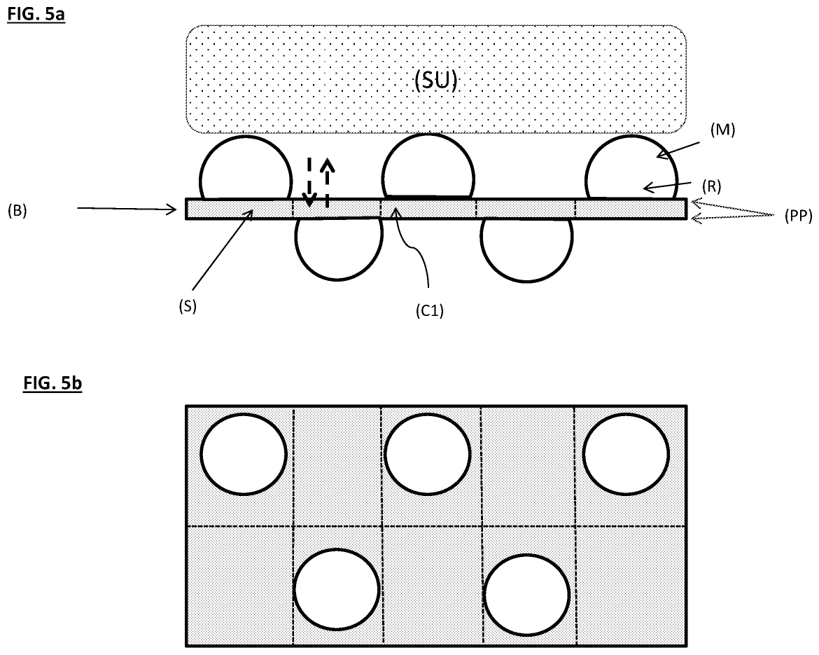

In the element (E) of FIG. 5, the solution or suspension (S) is contained in the cavity (C1) of the base (B) and the raised portions (R), in contact with or close to the substrate, contain air (without colour).

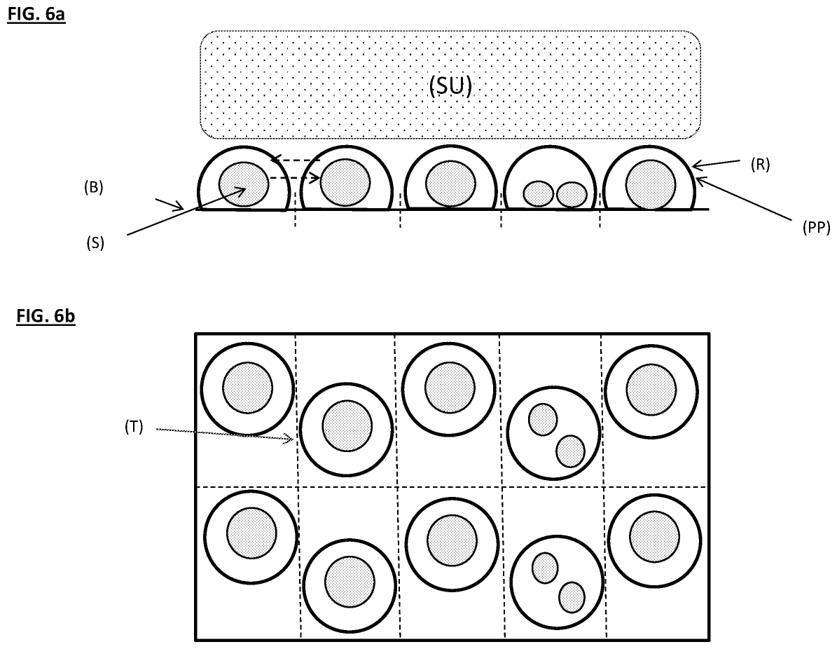

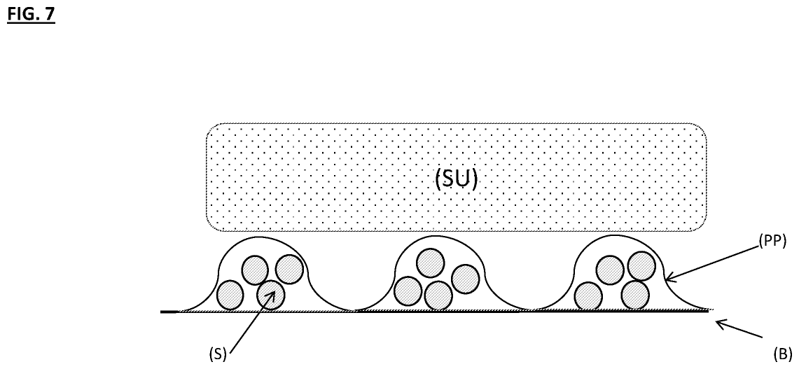

FIGS. 6 and 7 show an element (E) comprising raised portions (R) that contain capsules/spheres or microcapsules/microspheres containing the solution or suspension (S).

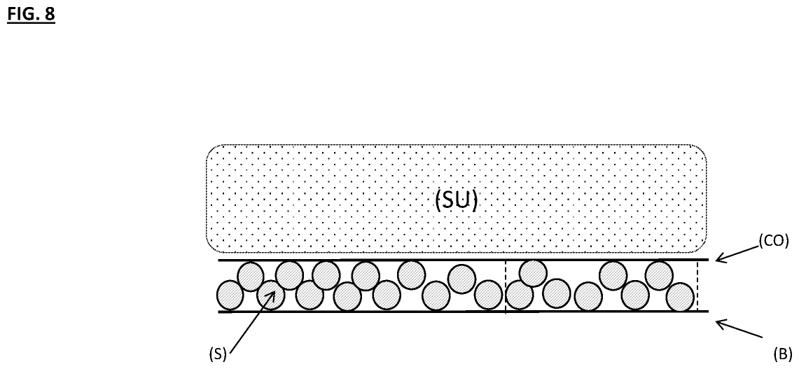

FIG. 8 shows an element (E) for moisture control in a container, wherein a plurality of microspheres or microcapsules (MSC), comprising an aqueous solution or suspension (S), are comprised between a base (B), comprising one or more layers of polymeric film, and a coating layer (CO) impervious to water and permeable to moisture positioned above at least one of the sides of the base (B).

The inventors have surprisingly found that the container according to the present invention improves the flow of moisture/water vapour present in the internal atmosphere or released by the substrate into the container, allowing the omnidirectional circulation thereof, i.e. in a direction tangent and/or perpendicular with respect to the parts of the food or of the food ingredient close to or in contact with the raised portions (R).

Said raised portions (R), indeed, make it possible to separate, at least partially, the food or the food ingredient from the film (PP) of the element (E) capable of exchanging moisture and also from a possible support surface. Through this separation, or distancing, it is possible to create a flow of water vapour that makes it possible to control in an optimal manner the moisture inside the container. The raised portions (R), which act as spacers, can have sizes from 0.5 mm to 1-2 cm, preferably they have a maximum diameter of between 10 mm and 30 mm, based on the overall size of the container and they can be on a single wall or on more than one wall of the element (E).

In the case of an element (E) having the raised portions (R) having a film (PP) capable of exchanging moisture on both sides of the base (B), the breathing takes place in all directions, when the element (E) is placed inside a closed chamber. In the case of an element (E) with raised portions (R) delimited by the film (PP) only on one of the two sides of the base (B), i.e. in which at least one part of the cavity (C2) is in contact with the film (PP) that makes it possible to exchange moisture with the outside of the cavity, the other walls of the element (E) can be impermeable to moisture and breathing can take place only on the side of the base (B) with the raised portions (R).

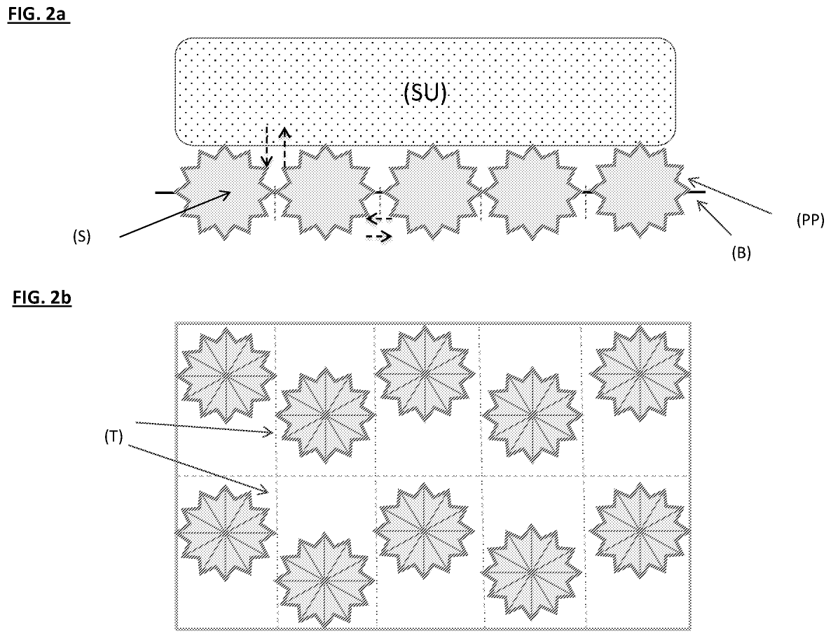

The element according to the present invention allows the increase in the breathing surface with a negligible increase in the volume occupied. The shape of the raised portions (R) is such as to be able to minimise the support surface and maximise the exchange surface. As non-limiting examples, the ellipsoidal/spherical shape or the “star” shape indicated in the attached FIG. 2 are preferred.

In a preferred embodiment, the raised portions (R) are shaped like a semi-ellipsoid/semi-sphere or a three-dimensional Gaussian, with a regular or irregular surface, as indicated in the attached FIG. 1.

Each of said raised portions (R) defines an internal cavity and the raised portions (R) are distanced from one another so as to allow the passage of gaseous flux between the raised portions (R).

As a result, the exchange of moisture between content of the container and element (E) for internal moisture control is much more efficient and requires a smaller amount of aqueous solution or suspension with respect to the devices of the prior art.

In a preferred embodiment, in the element (E) the at least two raised portions (R) contain the solution or suspension (S). Non-limiting examples of this embodiment are illustrated in FIGS. 1-4.

In a preferred embodiment, in the element (E) the at least two raised portions (R) comprise a gas, preferably air. A non-limiting example of this embodiment is illustrated in FIG. 5, where the raised portions (R) contain only air.

In a preferred embodiment, at least two raised portions (R) comprise the aqueous solution or suspension (S) and at least two raised portions (R) comprise a gas, preferably air. Advantageously, in this preferred embodiment the element can have the shape of a film able to be used to package a moisture-sensitive product during transportation, where part of the raised portions can act as padding, as happens in the packaging film with raised portions filled with air (“plurisphere”, “millebolle” or Bubble Wrap® produced by Sealed Air Inc.).

As a non-limiting example, some or all of the outer raised portions, i.e. not in contact with the substrate (SU), of the film can be filled with air and some or all of the inner raised portions (R), i.e. in contact with the substrate (SU), can be filled with the saline solution, or it is possible to alternate raised portions with the saline solution and some with air on one or on both sides of the film.

In a preferred embodiment, at least some of the raised portions (R) contain water, alternating with raised portions (R) containing the solution or suspension (S). This embodiment is useful for preserving and/or seasoning in environments with particularly low humidity.

In a preferred embodiment, the element (E) according to the present invention is prepared from an analogous element comprising only salt and a gelling agent inside the raised portions/cavities. At the moment of use, the film is hydrated with water, which penetrates into the raised portions/cavities where the salt is present. In this way a practically saturated saline solution is formed. Using a membrane with low permeability index the water enters, but after being captured by the gel, it will not be readily released. It is also possible to use two films coupled with an outer film that is very permeable to water and an inner film with lower permeability index, in order to promote the entry of water and hinder the exit thereof. The same process, starting from particles/microparticles containing a salt in solid state, can be carried out for the preparation of the embodiment of the invention wherein inside the cavity/raised portions there are capsules, spheres, microcapsules or microspheres. In a preferred embodiment, in at least some of the raised portions (R) the solution or suspension (S) is contained in one or more capsules or spheres (CS) having an outer shell made of polymeric material and containing the solution or suspension (S). In a preferred embodiment, the outer shell of said capsule or sphere (CS) comprises polyvinyl alcohol (PVA), gelatine, vegetable or animal, or cross-linked alginate.

In a preferred embodiment, the at least one capsule or sphere (CS) has maximum dimensions comprised between 1 micrometre and 1 cm, preferably from 2 micrometres to 1 mm or from 200 to 600 micrometres or from 2 to 5 mm.

Said capsule or sphere made of polymeric material can be prepared, for example, using methods for producing capsules or “pods” typical of the field of detergents.

A plastic film, as a non-limiting example polyvinyl alcohol (PVA) or a derivative thereof, is thermoformed through passage over a flat mould and application of the vacuum under the mould, obtaining recesses in which the saturated saline solution is dosed. A second film is applied above to close the capsules or spheres with a water-tight seal. As a function of the mould it is possible to form capsules or spheres having a shape and size even of a few mm.

Said capsule or sphere made of polymeric material (CS) can also be produced by microencapsulation, for example by using the production process for gel capsules, used in the food and pharmaceutical field, for producing single capsules or spheres or in films containing the capsules or spheres, which contain the solution or suspension (S).

In the microencapsulation process capsules are obtained with typical dimensions from 0.5 to 2 mm or more. The capsules can be obtained in the form of soft capsules (soft gel), spheres of hydrogel, or capsules of plastic material.

Soft capsules (soft gel) can enclose the saturated solution in gelatine (typically animal, but it is also possible to use vegetable gelatine). This process, normally used to produce capsules for pharmaceutical, cosmetic and nutraceutical use, involves the use of specific process lines that prepare the molten encapsulating material. The molten gelatine is then partially cooled through spreading over a pre-cooling roller that allows the transition to a rubbery state obtaining a thin film of gelatine. Two of these formed sheets are sent to the filling system that consists of two hollow moulding/forming rollers. The passage of the sheets of gelatine between the two rollers allows the simultaneous formation of the capsules and the filling with the saturated solution that is pumped with a dosing system. The capsules thus prepared are cooled to allow the complete cooling of the outer shell, obtaining rigidity and stability. The capsules can also be formed through a flat moulding system, wherein a first sheet of gelatine is placed above a flat mould. By applying the vacuum (process similar to thermoforming) the sheet of gelatine adheres to the mould and the half-shells of the capsules form.

These are filled with the saturated saline solution or suspension (S) and then steps are taken to form and lay a second sheet of gelatine on top to close the capsules.

This process makes it possible to obtain capsules with an adjustable mechanical resistance also based on the formulation of the gelatine solution. The exit can be made with single spheres or in a reel and the machine can be of the drum or flat type.

Through this process it is possible to form single capsules or reels.

For the production of the spheres it is also possible to use a process called spherification or gelling, through which spheres of hydrogel are produced, in an analogous way to the ionotropic gelling microencapsulation process.

In this case, it is necessary to add alginate (or another polyelectrolyte) to the saline solution, this is then poured in the form of small droplets in a liquid bath containing a calcium salt (polyvalent cation) for which reason the alginate at the surface of the droplets of saline solution complexes with the calcium, solidifying.

The reverse spherification process is based on the same principle, with the difference that the calcium is present in the saline solution and this is dripped into a bath containing alginate.

The mechanical resistance of the spheres thus obtained is less than soft capsules.

For the encapsulation of the spheres or capsules (CS) inside the raised portions (R) delimited by the film (PP), different processes are possible, including:

a) production of the raised portions in the same production flow of the spheres or capsules that are subsequently laminated inside the raised portions (R);

b) formation of blisters containing spheres/capsules using the machinery normally used to create blisters typically used for tablets/capsules of drugs. The plastic film is pre-made, has cavities where the sphere or capsule (CS) is inserted and then it is closed with another plastic film. In the case of the present invention, differently from blisters for drugs, the film that forms the base is not deformable. The system can also be used to make the bottom of a rigid container;

c) the spheres or capsules (CS) can be arranged on an adhesive film used to couple (through lamination) two different materials that form, respectively, the base (B) and the coating layer (CO) impervious to water and permeable to moisture, or dispersed in a coating material that is applied in fluid form above a plastic or non-plastic film, then subjected to drying, and then closed through lamination with the coating layer (CO).

In order to create raised portions containing spheres or capsules (CS) of saline solution or suspension it will be necessary to use a partial/selective “coating” with deposit only in some areas of the film. A non-limiting example of this embodiment is illustrated in FIG. 7.

Some methods indicated for this invention can be anilox coater, flexo coater or silk coater.

In printing, anilox is a method used to supply a measured amount of ink or paint to a flexographic plate. An anilox roller is a hard cylinder, usually built with a steel or aluminium core that is coated by an industrial ceramic the surface of which contains millions of very thin pits, known as cells. During printing, the roll of anilox is covered with ink or another element that then transfers onto the flexographic printing plate. The number, size and geometry of the anilox cells determine the amount of ink or paint or other solvent that the anilox roller dispenses on the plate. Flexography is a form of printing process that uses a plate in flexible raised portion. It is widely used for printing on non-porous supports required for various types of packages for food.

Screen printing is a printing technique in which a netting is used to transfer the ink or a paint onto a substrate, except in the areas made impermeable to ink/paint by a block. A blade (called doctor blade) is moved through the frame to fill the openings of the open meshes and in the reverse stroke ensures that the excess ink/paint is removed.

The term lamination is meant to indicate the combination of 2 or more juxtaposed films.

The application of a second film through lamination is widely used in the field of packaging.

The specific technical terms “laminated”, “coupled” and “polycoupled” are practically synonymous and refer to multi-layer thin structures obtained by combining materials such as paper, plastic or aluminium. The materials are combined, or rather coupled, by adhesion, with particular techniques that provide for the use of specific adhesive substances, of various kinds, which are deposited on the single materials in different ways, depending on the properties of the material itself.

Depending on the materials to be laminated, the different coupling/lamination processes can be divided into two, i.e. dry or wet.

Dry coupling provides for the union of two supports with application of adhesive on one of the two, the passage thereof in an oven to make the solvent evaporate and then the union and compression with the second layer. Depending on the composition of the adhesive, the solid residues thereof will be sticky or will require the passage of the multi-layer structure through the heated coupling rollers that compress the two layers to achieve the lamination thereof. This technique is used for coupling of the plastic films, and for the coupling of non-porous materials in general.

Wet coupling provides for the use of an adhesive applied on one of the two supports, the union and compression with the second material and the passage of the two materials already coupled in a heating environment, like an oven, from which the solvent used will evaporate. This technique presumes that one of the two materials that will make up the laminate is porous, like, for example, paper.

The lamination of the plastic films is generally further distinguished in 5 types, i.e. thermal lamination, low-temperature thermal lamination, solvent-free lamination, lamination with pressure-sensitive films and lamination with closure with liquid.

In the case in which it is wished to obtain an element (E) that has raised portions on the surface, it is also possible to apply a so-called weft lamination, i.e. with vertical and horizontal gluing lines.

The raised portion (R) can consist of a film (PP) impervious to water and permeable to moisture on one side of the surface and of non-breathable film on a different side of the surface. Alternatively, the entire surface of the raised portion (R) can consist of a film (PP) impervious to water and permeable to moisture.

In the case of spheres or capsules (CS) with water vapour-breathable casing/shell, moisture control can be obtained by placing the element (E) that comprises said spheres in the usage environment, without an activation step of the transpiration itself.

In a more preferred embodiment, said polymeric material is impervious to water and permeable to moisture.

The spheres/capsules with non-breathable casing can be activated by breaking of the outer coating. The breaking can for example take place through the passage of the film inside two rollers that break the spheres/capsules by exerting a pressure.

In a more preferred embodiment, said polymeric material is impermeable to water and moisture and said capsule or sphere releases the solution or suspension (S) after the breaking of the polymeric material.

In all of the embodiments described above, and in the relative preparation methods, microcapsules or microspheres can be used.

In a preferred embodiment of the invention, said capsule or sphere of polymeric material (CS) is a microcapsule or microsphere, i.e. a capsule or sphere having maximum dimensions smaller than 1000 micrometres, preferably from 200 to 600 and it can be prepared, for example, through microencapsulation.

Microcapsules are systems consisting of a liquid, solid or semi-solid central core, surrounded by a continuous polymeric coating or by a membrane. Microspheres, on the other hand, are microparticles formed from a homogeneous matrix in which it is no longer possible to distinguish the core and the coating.

Microencapsulation is a technology that makes it possible to encapsulate solid, liquid or gaseous materials in the form of microparticles widely used in the fields of medicine, cosmetics, food, textiles and advanced materials. The advantage of this technology is that of being able to have the inner material (core) completely coated and protected by the outer environment by the coating material, also called wall material (wall, shell material). The correct choice of the encapsulating material and of the preparation method makes it possible to keep the properties of the encapsulated material unchanged.

The microencapsulation methods can be divided into three categories based on the formation mechanisms and the state of the coating:

1) Physical methods: such as spray drying, spray cooling, air suspension, extrusion, solvent evaporation.

These methods exploit physical and mechanical principles and the coating forms following a solid-liquid phase transition after heating or reduction of solubility due to the evaporation of the solvent.

2) Chemical methods: such as interfacial polymerization and in situ polymerization. These methods are based on chemical reactions in which the monomers with small molecules polymerise forming the coating.

3) Physical-chemical methods: such as simple coacervation, complex coacervation, phase separation. In these methods the materials of the coating are pre-dissolved and then made to precipitate exploiting a change in temperature, pH or concentration of an electrolyte. The material precipitates and is gradually deposited on the surface of the inner component.

In the case of the present invention the microencapsulation technique is aimed at promoting the manipulation of the saline solution during the production process of the film and possibly allowing the activation of the moisture control in a step after production.

For the purposes of the present invention, it is wished to microencapsulate a solution or suspension (S) containing water, salts and possible/other agents. Some additional components, like a possible thickener, could be provided in the outer coating of the microcapsule. It is also possible for water and salt, and possible other components, to be encapsulated and deposited separately, to be then mixed and activated afterwards.

The physical methods usually lead to obtaining microcapsules with a low moisture content and even powders and are not suitable for the purposes of the present invention. However, the chemical and physical-chemical methods, like those illustrated hereinafter as an example, are suitable.

Interfacial polymerization is one of the most suitable methods for the microencapsulation of liquids, according to a process that consists of three base steps:

a) dispersing an aqueous solution in an organic/oily phase with the formation of a water-in-oil emulsion;

b) forming the polymeric membrane at the surface of the water droplets started by the addition of a soluble reactant in the organic/oily phase;

c) separating the microcapsules containing the aqueous phase of the organic phase.

The production of the membranes of the microcapsules through other chemical methods exploits similar systems based on modifications of the emulsification process.

In complex coacervation, two or more polymeric materials of opposite charge combine by electrostatic interaction in appropriate conditions (for example a change of pH or temperature) and gradually deposit on the surface of the core forming the shell and reducing solubility.

Different polymers can be used for the formation of the membranes, such as gelatine, Arabic gum, chitosan, etc.

Ionotropic gelling can be considered another physical-chemical encapsulation system, in which multi-unit polymeric systems are produced, typically of spheroidal shape and with a diameter that can vary from a few p.m to a few mm similarly to the method described above for the preparation of spheres through spherification or gelling. The process exploits the ability of carboxylic groups of some polyelectrolyte polymers (such as alginate) to chelate divalent ions (for example Ca²⁺), leading to the formation of rigid three-dimensional lattices, similarly to the method described above for the preparation of spheres through spherification or gelling. It is also possible to exploit the polyelectrolytic complexing technique to add another layer of a polyelectrolyte of opposite charge and increase the barrier and resistance properties of the capsules.

The microcapsules, obtained as a non-limiting example with the techniques indicated earlier, or a suspension thereof in suitable solvent or other liquid, can be applied to plastic films by exploiting the normal “coating” and lamination technologies.

In a preferred embodiment, the microcapsules are dispersed in the coating material that is applied in fluid form above a plastic or non-plastic film and then subjected to drying. In a preferred embodiment, the microcapsules are dispersed in an adhesive solution used to couple (through lamination) two different materials that form, respectively, the base (B) and the coating layer (CO) impervious to water and permeable to moisture. Also in this case, a step of drying the adhesive is provided for but it involves conditions less aggressive than those necessary for the process comprising drying before lamination.

The element (E) containing microcapsule and/or microspheres can be prepared through lamination, i.e. application of a coating layer (CO) to a continuous layer of microcapsules or microspheres obtained previously.

In an embodiment, the present invention concerns an element (E) for moisture control in a container, comprising at least:
a base (B) comprising one or more layers of polymeric film, optionally stretchable so that the element (E) may be adapted to said container,
a coating layer (CO) impervious to water and permeable to moisture positioned on at least one of the sides of the base (B);
a plurality of microspheres or microcapsules (MSC), having maximum dimensions from 1 to 1000 micrometres, preferably from 200 to 600 micrometres, comprising an aqueous solution or suspension (S) comprising at least one food grade substance and selected from an inorganic or organic salt, a sugar, a polyol, a polyprotic acid and/or mixtures thereof,
   wherein the microspheres or microcapsules (MSC) are comprised between the coating layer (CO) and the at least one side of the base (B) adjacent to the coating layer (CO).

The microcapsules are deposited uniformly over the entire film, called “fully loaded”. A limiting example of this embodiment is illustrated in FIG. 8.

In the present invention, it is preferable to use “coating” technologies that allow a deposit of a relatively thick layer of material, for example in a range from 2 to 3 mm, so as to be able to effectively and quickly adjust the moisture, possibly also with many layers of microcapsules.

In the present invention, the various printing and lamination systems described earlier can be used to transfer the microcapsules immersed in a solvent or water-based carrier on the surface of a film and to laminate the layer thus obtained.

The microspheres or microcapsules (MSC) can have all the characteristics as earlier described .

In a preferred embodiment, the microcapsules have an outer shell that comprises polyvinyl alcohol (PVA), gelatine, vegetable or animal, or cross-linked alginate. In a preferred embodiment, in the element (E) the coating layer (CO) comprises or consists of at least one from paper, a fabric, a polymeric material selected from polyvinyl chloride, microporous polyethylene, high density polyethylene, low density polyethylene, cellophane, polyethylene terephthalate, biaxially-oriented polyethylene terephthalate, polycarbonate, ethyl vinyl alcohol, polyamide, polystyrene, oriented polystyrene, ethylene vinyl acetate, polyurethane, polyvinyl alcohol, polylactic acid, cellulose derivatives such as ethylcellulose or cellulose acetate, starch, polyhydroxyalkanoates, polybutylene succinate, nylon, or another food-grade polymeric material.

The activation of the breathing can be carried out through breaking of the microspheres or microcapsules. During lamination, as a function of the mechanical resistance of the microspheres or microcapsules, the breaking thereof can occur with leak of the saline solution or suspension that will thus be trapped between two layers of breathable and impermeable material. The formulation of the capsules can, indeed, be studied to provide for the release in the adhesive.

In a preferred embodiment, at least some of the raised portions (R) contain a cooling agent, like, without limitation, dry ice, ice or brine, which makes it possible to keep the product refrigerated during transportation or storage.

In a preferred embodiment, the raised portions (R) have an air-filled small perforated cap on top. Said small perforated cap, at the moment when a substrate is positioned in contact (direct or indirect) with the element (E), promotes the transpiration of the air contained in it towards the outside through the effect of the pressure exerted by the substrate on the raised portions (R). Such an embodiment thus makes it possible to achieve the desired equilibrium moisture more quickly.

In an embodiment, said small perforated caps can be ellipsoidal/spherical or semi-ellipsoidal/semi-spherical in shape.

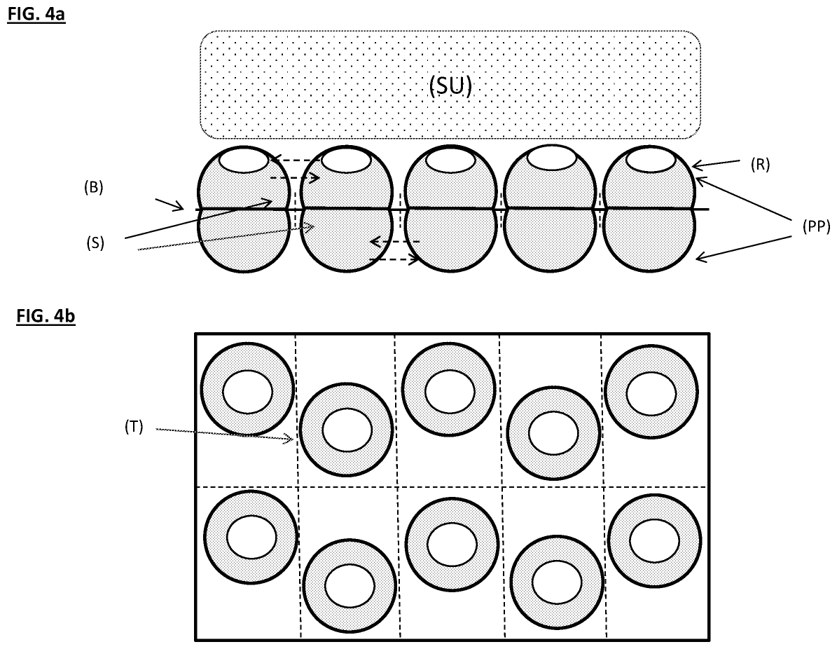

A non-limiting example of this embodiment is illustrated in FIG. 1 and in FIG. 4 (the holes of the caps are not shown in the image).

In a preferred embodiment, in the element (E) the at least two raised portions (R), positioned on one or on both sides of the base, contain the solution or suspension (S) in the cavity (C2), optionally in which at least one part of (C2) is occupied by a gas, preferably air.

In a preferred embodiment, the internal cavity (C1) is not present in said base (B) of the element (E) according to the present invention, as a non-limiting example, as illustrated in FIGS. 1-4. In a preferred embodiment, the element (E) for moisture control can be divided into portions through weakened lines and pre-arranged breaking points, such as, for example, with perforations, like those represented in FIGS. 1-4, which make it possible to divide the element (E) into portions, for example making a cut or a tear at said breaking points, so as to be able to reduce the size or shape the element (E), based on the shape of the container and/or the food contained.

Thanks to the presence of a variable number of separate raised portions (R), it is possible to easily change the shape of the element (E) to adapt it to the space available inside the container.

Making an element (E) with separate raised portions, instead of a single container containing a saline solution as described in the prior art, makes it possible to adapt the size and the shape of the element (E) for moisture control to any container for food or for a food ingredient, even if large, also being able to wrap around the content, if necessary. The characteristics of the element (E) as described above, also make it possible to produce it in the form of a bag or a sheet to be positioned in a tray or in a container having practically any shape and size.

In an embodiment, the base (B) consists of one or more layers of polymeric film that is stretchable so that the element (E) can perfectly adapt to the container in which it is integrated.

As a non-limiting example, such a stretchable polymeric layer can consist of low-density linear polyethylene, plasticized polyvinylchloride or starch.

In a preferred embodiment, in the element (E) the at least two raised portions (R) are delimited at least in part, by a polymeric membrane (M) that is impermeable to moisture, i.e. at least one part of the cavity (C2) is in contact with said polymeric membrane (M) that does not allow the exchange of moisture between the inside and the outside of the cavity (C2). More preferably, the at least two raised portions (R) do not contain the solution (S), even more preferably said at least two raised portions (R) contain only a gas. As a non-limiting example, said gas can be air.

A non-limiting example of this embodiment is illustrated in FIG. 5.

The element (E) according to the present invention can be produced in the form of a bag, for example as a single-dose bag with three of four welds, as single bags or in a reel. Every bag (or cell or pack) can, as a non-limiting example, be about 30×50 mm in size or less. The closure of the bags can be carried out through ultrasound closure technology, which can cross the filling material and, therefore, allow the bag to be completely filled.

If a plurality of bags are produced in the form of a reel, it is possible to make a horizontal perforation to facilitate the tearing of the single elements (E).

The element (E) can be in the form of units, for example spherical in shape, or a bag obtained with the various production systems indicated above. The spherical-shaped elements or bags can be used loose, i.e. not contained inside films or further containment systems, and arranged inside a container where a product must be preserved at constant moisture. As well as having the possibility of controlling moisture, the spheres/bags also have the function of absorbing impacts, similarly to the function commonly carried out by packaging materials like “chips” of polystyrene foam.

In a preferred embodiment, said polymeric membrane (M) impermeable to moisture comprises at least one anti-bacterial, bacteriostatic, mycostatic and/or antimycotic food-grade substance, and/or a substance which changes colour in relation to the moisture degree in the container.

In a preferred embodiment, the element (E) or the container associated with it contains a humidity indicator card (HIC).

As a non-limiting example, said anti-bacterial, bacteriostatic, mycostatic and/or antimycotic food-grade substance can be sorbic acid, potassium sorbate, calcium sorbate, benzoic acid, sodium benzoate, ethyl para-hydroxybenzoate, sodium sulphite, nisin, sodium nitrite, propionic acid, sodium, propionate or calcium propionate.

As a non-limiting example, said substance which changes colour in relation to the degree of moisture in the container can be a compound belonging to the class of thiazines like for example methylene blue or thionine.

In an embodiment, said polymeric membrane (M) can also comprise food-safe anti-oxidant substances, oxygen scavengers and ethylene scavengers.

As a non-limiting example, said anti-oxidant substance can be a compound belonging to the family of tocopherols like a-tocopherol.

As a non-limiting example, said oxygen scavenger can be ascorbic acid, iron-based compounds or sodium bicarbonate.

As a non-limiting example, said ethylene scavenger can be a system based on zeolites or active carbon.

In a preferred embodiment, the film (PP) impervious to water and permeable to moisture in the element (E) consists of, or comprises, paper, a fabric, at least one polymeric material, preferably selected from polyvinyl chloride, microporous polyethylene, high density polyethylene, low density polyethylene, cellophane, polyethylene terephthalate, biaxially-oriented polyethylene terephthalate, polycarbonate, ethyl vinyl alcohol, polyamide, polystyrene, oriented polystyrene, ethylene vinyl acetate, polyurethane, polyvinyl alcohol, polylactic acid, cellulose derivatives such as ethylcellulose or cellulose acetate, starch, polyhydroxyalkanoates, polybutylene succinate, nylon or another food-safe polymeric material.

As a non-limiting example, it is possible to use paper (cellulose) added to with resins, paraffin, alum, shellac, waxes (like bee's wax) that make it impermeable to water and permeable to water vapour.

In a preferred embodiment, on at least one side the element (E) has an adhesive substance so as to be able to apply it easily to materials like glass, wood, plastic, metal and other materials that can be found inside containers for moisture-sensitive substrates. The adhesive can be in the permanent version or in the removable version. As a non-limiting example, the adhesives can be of the type for emulsion, hot-melt adhesives and solvent-based adhesives. All of the adhesives can be either acrylic based or rubber based.

In a preferred embodiment, the film (PP) consists of, or comprises, a film of plastic material impermeable to moisture that has microperforations of a size that allows the passage of moisture and that does not allow the passage of water. A non-limiting example of said impermeable plastic materials is polypropylene. The perforations can be made through laser technology. As a non-limiting example, the film (PP) can have a density of holes that ranges from 0.5 to 25 holes/cm² and/or a thickness from 15 to 40 microns. The holes indicatively are from 20 to 50 microns.

The breathability of the polymeric material is preferably equal to, or greater than, 150 g/m²/day of water vapour. The impermeability of the polymeric material is preferably greater than 1000 mm of water column.

The aqueous solution or suspension (S) of the element (E) according to the present invention comprises at least one food grade substance selected from an inorganic or organic salt, a sugar, a polyol or a polyprotic acid and/or mixtures thereof.

As non-limiting examples, the solution (S) can contain, as inorganic salt, one from sodium chloride, ammonium sulphate and mixtures thereof, as organic salt, one from sodium citrate and sodium acetate and mixtures thereof, as polyol, one from glycerol, sorbitol and mixtures thereof and/or as polyprotic acid sulphuric acid.

As a non-limiting example, the concentration of the polyol, preferably glycerol, is preferably between 30 and 70%.

The saturated solution or aqueous suspension (S) preferably consists of water and sodium chloride.

Preferably, said saturated solution or aqueous suspension (S) maintains a substantially constant humidity fixed point (HFP) as the temperature changes, more precisely comprised between 75.7% at 5° C. and 75.1% at 30° C., at a pressure of 1 atmosphere. The relative humidity of 75% is what is advised for optimal storage of cold cuts and cheeses. Sodium chloride, i.e. normal table salt, also does not cause substantial contamination of the food product, such as cold cuts and cheeses to be preserved, in the case of accidental breaking.

The aqueous solution or suspension (S) can also contain, as an alternative or in addition to sodium chloride, at least one substance from glucose, glycerol, sulphuric acid, propylene glycol, saccharose, fructose, sorbitol, mannitol, xylitol, trehalose, sodium citrate, potassium citrate, copper sulphate, sodium nitrate, sodium nitrite, potassium chloride, ammonium sulphate, potassium nitrate, potassium sulphate, potassium carbonate, magnesium chloride, potassium acetate, sodium acetate, sodium hydroxide, potassium hydroxide, potassium lactate, sodium malate, sodium tartrate, sodium formiate or other food-safe substances.

In a preferred embodiment of the present invention, said aqueous solution or suspension (S) also comprises at least one thickening agent, preferably selected from a thickener of synthetic origin, like sodium polyacrylate, a vegetable gum, like a guar or xanthan gum, an alginate or a derivative of an alginate, like propylene glycol alginate, cellulose and derivatives thereof, like hydroxypropylcellulose and hydroxypropylmethylcellulose, starch, like rice or maize starch, a silicate, like calcium or magnesium silicate, a natural agent selected from E420-429, such as sorbitol or mannitol, a natural emulsifier selected from E440-449, such as pectin and gelatine. The E numbers refer to the European standards on food additives, like, without limitation, EU regulation No. 231/2012of the commission of 9 Mar. 2012 that establishes the specifications of the food additives listed in attachments II and III of regulation (CE) no. 1333/2008 of the European Parliament and of the Council.

The concentration of the thickening agent present in (S) is preferably between 0.2% and 2.5% by weight with respect to the total weight of (S).

The addition of the thickener to the aqueous solution or suspension (S) makes it possible to use a more breathable polymeric material, reducing the impermeability thereof. The addition of the thickener to the aqueous suspension (S) also makes it possible to keep the suspension itself homogeneous.

In a preferred embodiment, the suspension or aqueous solution (S) also contains glycerol or polyols analogous to glycerol. The increase in concentration of glycerol decreases the humidity fixed point of the solution saturated with salt, relatively independently from the temperature.

For example, in the presence of a percentage of 32% of glycerol (expressed as g of glycerol per 100 g of solution) it is possible to obtain a relative humidity fixed point of 90% that makes it possible to hydrate, whereas in the presence of a percentage of 72% of glycerol it is possible to obtain a relative humidity fixed point of 60% that makes it possible to dehydrate (and therefore season in optimal conditions) food like cold cuts and cheeses.

It is also important to emphasise how by operating inside the aforementioned range of concentrations of glycerol it is possible to effectively control the relative humidity fixed point, since accidental small changes in concentration of glycerol do not cause significant changes in the relative humidity fixed point values.

In a preferred embodiment of the present invention, the solution or suspension (S) also contains at least one substance selected from natural flavourings, extracts, preservatives, pH regulators, anti-oxidants, oxygen scavengers, ethylene scavengers, substances conventionally used in food processing, like wine, and similar.

In an alternative embodiment, some cavities (C1) and (C2) can contain substances capable of changing colour based on the percentage humidity in the atmosphere of the container. As a non-limiting example, some cavities can contain a compound belonging to the class of thiazines like for example methylene blue or thionine.

In an embodiment, the present invention relates to a container for storage in controlled moisture of a substrate, preferably for preserving and/or seasoning food and food ingredients, comprising the element (E) for moisture control as defined above.

In a preferred embodiment, said container according to the present invention is in the shape of a sealable box or a single-use container, optionally comprising an atmosphere substantially consisting of one or more inert gases, preferably selected from nitrogen, carbon dioxide, a noble gas and mixtures thereof.

The container according to the present invention is easy to use, also for domestic use, unlike the use of vacuum or controlled-atmosphere containers, which require specific apparatuses for the removal of air and to introduce inert gases into the container.

In a preferred embodiment, in the container according to the present invention there is an adhesive separation film (P1) between the raised portions (R) and the environment of the container. Said film (P1) can be removed through a tear mechanism at the moment when the substrate, for example the food to be preserved in controlled moisture conditions, is inserted inside the container. A non-limiting example of a section of the container comprising said film (P1) is shown in FIG. 1. Said film can consist of or contain a polymeric material like, for example, polyvinyl chloride, microporous polyethylene, high density polyethylene, low density polyethylene, cellophane, polyethylene terephthalate, biaxially-oriented polyethylene terephthalate, polycarbonate, ethyl vinyl alcohol, polyamide, polystyrene, oriented polystyrene, ethylene vinyl acetate, polyurethane, polyvinyl alcohol, polylactic acid, cellulose derivatives such as ethylcellulose or cellulose acetate, starch, polyhydroxyalkanoates, polybutylene succinate, nylon or other food-safe polymeric materials.

In a preferred embodiment, in the container according to the present invention there is a layer capable of absorbing liquids, like a “pad” or a mat of the type normally used in containers for food use to absorb the liquids produced during the storage of food like meat, fish or fruit. As a non-limiting example, cellulose-based materials with high absorbent power and other absorbent chemical agents can be used as layer capable of absorbing liquids. The outside of the “pad” can also be shaped like a netting that promotes the draining of the liquid towards the absorbent inner layer.

The container according to the present invention can be in the form of a tray that has one or more elements (E) as described above on the bottom and/or on the sides.

The container according to the present invention can be used for preserving and/or for packaging, for example for delivery, material that are particularly sensitive to changes in humidity like works of art, musical instruments, electrical and electronic apparatuses and furnishings with wooden parts and similar.

The container according to the present invention can preferably be used in the food industry to preserve or season food or ingredients for food preparation.

Indeed, it is known that some types of food, including cold cuts, cheeses and other traditional preparations, must be seasoned, even for a number of months, before being consumed, also to improve the organoleptic characteristics thereof. During the seasoning process, it is generally necessary to control the humidity and temperature conditions, also to meet production criteria, in order to obtain an end product with the desired characteristics and avoid seasoning defects deriving from too dry atmosphere or from anomalous bacterial fermentations.

The container according to the present invention makes it possible to accurately control the moisture in the seasoning step and to produce seasoned food with the desired characteristics.

With a decrease in the humidity fixed point it is possible to obtain the dehydration of the food, useful for obtaining the seasoning, for example, of cheese or cold cuts, whereas with an increase in the humidity fixed point with respect to the optimal one of 75% hydration and, therefore, softening of the food is obtained.

In a preferred embodiment, the container according to the present invention is in the form of a closable box or a disposable sealed package.

In a preferred embodiment, said container, optionally in the form of a closable box or a disposable sealed package, contains an atmosphere consisting substantially of one or more inert gases like nitrogen, carbon dioxide, a noble gas, and mixtures thereof.

In an embodiment, the present invention relates to the use of the container as described above for preserving and/or seasoning a food or a food ingredient.

In a preferred embodiment, said container is used for preserving and/or seasoning at least one food from cold cuts, dairy products, fruit, vegetables, food preparations like sauces and pre-cooked food, ingredients for food preparations, a fish product and confectionery.

In a preferred embodiment, the present invention relates to the use of the container as described above for preserving, packaging and/or transporting moisture-sensitive substrates like artworks, musical instruments and furniture or objects of value containing or made from wood.

In an embodiment, the present invention concerns a method for preserving a food or a food ingredient comprising arranging said element or ingredient for elements in the container as described above and sealing the container in an air-tight manner. Once closed, the container can be placed in a refrigerated environment or at room temperature, based on the nature of the substrate to be preserved.

1. An element for moisture control in a container, comprising:
a base comprising one or more layers of polymeric film, optionally stretchable so that the element may be adapted to said container, wherein:
when the layers of said base are two or more, they optionally define at least one internal first cavity;
said base carries two or more raised portions made of polymeric material, positioned on one or on both sides of the base, each of said raised portions defining an internal second cavity and being distanced from each other so as to allow the passage of a gaseous flux between the two or more raised portions;
at least one of said first and/or second cavities contains a gas, preferably air, or an aqueous solution or suspension comprising at least one food grade substance selected from an inorganic or organic salt, a sugar, a polyol, a polyprotic acid and/or mixtures thereof, provided that;
at least one of the first and/or second cavities contains the solution or suspension and that
the at least one cavity containing the solution or suspension is enclosed, at least in part, by a film impervious to water and permeable to moisture.

2. The element according to claim 1, wherein the aqueous solution or suspension further comprises at least one thickening agent.

3. The element according to claim 1, wherein the film impervious to water and permeable to moisture comprises at least one of a paper, a fabric, a polymeric material selected from polyvinyl chloride, microporous polyethylene, high density polyethylene, low density polyethylene, cellophane, polyethylene terephthalate, biaxially-oriented polyethylene terephthalate, polycarbonate, ethyl vinyl alcohol, polyamide, polystyrene, oriented polystyrene, ethylene vinyl acetate, polyurethane, polyvinyl alcohol, polylactic acid, cellulose derivatives, ethylcellulose or cellulose acetate, a starch, polyhydroxyalkanoates, polybutylene succinate, nylon, or another food-grade polymeric material.

4. The element according to claim 1, wherein said at least two raised portions, positioned on one or on both sides of the base, contain the solution or suspension in the second cavity, optionally wherein at least one part of the second cavity is occupied by a gas and/or, optionally, wherein a part of the raised portions contains a gas and a part contains the solution or suspension.

5. The element according to claim 4, wherein the first internal cavity is not present in said base.

6. The element according to claim 1, wherein said at least two raised portions are enclosed, at least in part, by a polymeric membrane impervious to moisture and, preferably, contain gas.

7. The element according to claim 6, wherein said moisture-impervious polymeric membrane comprises at least one anti-bacterial, bacteriostatic, mycostatic and/or antimycotic food-grade substance, and/or a substance which changes colour in relation to the moisture degree in the container.

8. The element according to claim 6, wherein:
the base comprises at least two polymeric layers that define one or more internal first cavities and has two or more raised portions made of polymeric material, positioned on both sides of the base, wherein each of said elements in said raised portions defines an internal second cavity;
said at least one first cavity contains the aqueous solution or suspension and said at least one second cavity contains a gas.

9. A container for storage in controlled moisture of a substrate comprising the element for moisture control according to claim 1, optionally comprising an atmosphere consisting substantially of at least one inert gas.

10. Use of the container according to claim 9 comprising preserving and/or seasoning a food or a food ingredient.

11. The element according to claim 1, wherein said at least two raised portions contain at least one capsule or sphere having an outer shell and containing the solution or suspension.

12. The element according to claim 11, wherein the outer shell of said capsule or sphere comprises polyvinyl alcohol (PVA), vegetable or animal gelatine, or cross-linked alginate.

13. The element according to claim 11, wherein the at least one capsule or sphere has maximum dimensions of between 1 micrometre and 1 cm.

14. An element for moisture control in a container, comprising:
a base having two sides and comprising one or more layers of polymeric film, optionally stretchable so that the element may be adapted to fit said container,
a layer comprising a plurality of microspheres or microcapsules, having maximum dimensions from 1 to 1000 micrometres, comprising an aqueous solution or suspension comprising at least one food grade substance and selected from the group consisting of an inorganic or organic salt, a sugar, a polyol, a polyprotic acid and mixtures thereof, positioned in contact with at least one side of the base;
a coating layer impervious to water and permeable to moisture positioned in contact with the layer of microspheres or microcapsules on the outer side of the element.

15. The element according to claim 14, wherein the coating layer comprises at least one of paper, a fabric, a polymeric material selected from polyvinyl chloride, microporous polyethylene, high density polyethylene, low density polyethylene, cellophane, polyethylene terephthalate, biaxially-oriented polyethylene terephthalate, polycarbonate, ethyl vinyl alcohol, polyamide, polystyrene, oriented polystyrene, ethylene vinyl acetate, polyurethane, polyvinyl alcohol, polylactic acid, cellulose derivatives ethylcellulose, cellulose acetate, starch, polyhydroxyalkanoates, polybutylene succinate, nylon, or another food-grade polymeric material.

16. The element (E) according to claim 14, wherein the microcapsules have an outer shell that comprises polyvinyl alcohol, vegetable or animal gelatine, or cross-linked alginate.

17. A method for producing the element according to claim 14, comprising the following steps:
i. applying at least one layer of microspheres or microcapsules, optionally dispersed in a coating material or in an adhesive material, on at least one side of the base;
ii. applying the coating layer on the at least one layer of microspheres or microcapsules obtained in step i.;
iii. laminating the coating layer so as to obtain the adhesion thereof to the layer applied in step i. on the outer side of the element.

18. The element according to claim 2, wherein the thickening agent is taken from the group consisting of sodium polyacrylate, a vegetable gum, a guar or xanthan gum, an alginate or a derivative of an alginate, a propylene glycol alginate, cellulose, cellulose derivatives, hydroxypropylcellulose, hydroxypropylmethylcellulose, starch, rice or maize starch, a silicate, calcium or magnesium silicate, a natural agent selected from E420-429, a sorbitol or mannitol, a natural emulsifier selected from E440-449, pectin, gelatine and combinations thereof.

19. The container according to claim 9, wherein the container is configured in the shape of a sealable box or a single-use container for preserving and/or seasoning food and food ingredients, optionally comprising an atmosphere consisting substantially of at least one inert gas.

20. The element according to claim 11, wherein the at least one capsule or sphere has maximum dimensions of between 2 micrometres to 1 mm.
